(19) United States
(12) Patent Application Publication
(10) Pub. No.: US 2017/0034266 A1
(43) Pub. Date: Feb. 2, 2017

(54) System and Method for the Departmentalization of Structured Content on a Website (URL) through a Secure Content Management System

(71) Applicant: Anthony I. Lopez, JR., Dana Point, CA (US)

(72) Inventor: Anthony I. Lopez, JR., Dana Point, CA (US)

(21) Appl. No.: 14/812,462

(22) Filed: Jul. 29, 2015

(51) Int. Cl. H04L 29/08; G06F 17/30; H04L 29/06

(52) U.S. Cl. CPC H04L 67/1097; H04L 67/42; H04L 67/02; G06F 17/30557; G06F 17/30598; G06F 17/30312; G06F 17/30371

(57) ABSTRACT

The present invention includes a system and method for departmentalization of structured content on a website (URL) through a secure content management system. The invention provides a method for auto-categorization and classification of any content from users' hard drives or from the Internet stored in the content management system. Content is classified by way of the URL, Supporting URL, Content Detail URL, and Originating URL and categorically classified. As content is modified in any way (i.e. edited, deleted) in the content management system, the same content displayed and published on the website (URL) is also automatically modified throughout all devices where the website (URL) is rendered. During these processes, the content is separated and indexed by way of its component parts. The invention ensures the persistence of content stored from the Internet whether or not the content's supporting URL or originating URL still exists or is deleted or modified. The invention provides a method for classification of content by associations including but not limited to who, what, where when, and why whereby decoupling meta data and content occurs, marking the same content multiple ways which facilitates multiple pathways to retrieving specific content. The invention further includes a system and method whereby content stored in the content management system is visually displayed in a dynamic hierarchy that is current in time. Users of the system are able to initially view relevant content ranked by time. Further, users may search for specific visual content according to the content's associated data thus eliminating time and repetitive actions. The system pushes relevant visual content with associated data to users in real time over a network as a request for data is triggered, providing users with continuous and current hierarchical visual information. The system and method may be used on any and all devices including but not limited to desktop/laptop, mobile and tablet devices. Content shared through the system is automatically rendered throughout all devices using the system.

### DEFINITIONS

Prior to describing the present invention, it is useful to provide definitions for some key terms used herein.

Content: broadly interpreted to include, without exclusion, digital resource that is, or could be accessed on the Internet such as image files, audio files, text files, video files, and any combinations and equivalents thereof.

Desired Content: broadly interpreted to include, without exclusion, any specific wanted data on a digital content platform, such as images, audio, text, video, and any combinations and equivalents thereof.

Atomic Content: broadly interpreted as a single element such as an image, text, or video that is not naturally divisible into smaller units.

Composite Content: broadly interpreted as a content type which has many atomic resources within it, for example, a html web page consisting of many script and image files.

Associated Content: broadly interpreted to include, without exclusion, any and all data of interest, desired or not, associated with an element—whether said element is atomic or composite. Most often, an element of content will have associated content within its composite parent content item.

URL (Uniform Resource Locator): broadly interpreted as a character string that constitutes a reference to atomic and/or composite resources on the World Wide Web.

Supporting URL or Source Location: a URL describing the location of an element or atomic content, which makes up composite content.

Originating URL or Source Location: a URL where original content comes from (typically composite).

Content Detail URL: some atomic content that is embedded in a particular instance of composite content will have associated code indicating a URL which provides additional information about said content. This URL is referred to as the content detail URL.

Retrieve: broadly interpreted as accessing or obtaining content.

File Management System: broadly interpreted as a system that organizes and keeps track of files.

Unstructured Content: broadly interpreted as information that either does not have a pre-defined data model or is not organized in a pre-defined manner.

Content Management System: broadly interpreted as a computer application that allows publishing, editing, modifying, organizing and deleting of content as well as maintenance from a central interface.

Visually Displayed Structured Content: broadly interpreted as content that is organized in a pre-defined manner presented in a pictorial, graphical or any other visual method.

Departmentalized Content: broadly interpreted as structured content that is organized in a categorical and classified pre-defined data model in a Content Management System which is visually depicted in a separated, organized and departmentalized method.

Website: broadly interpreted as a location connected to the Internet that maintains one or more pages on the World Wide Web.

### BACKGROUND OF THE INVENTION

Typical websites today vary in size, design and purpose. There are millions of different types of websites today used to provide information, advertise or engage in e-commerce. The user, from a number of unstructured content sources, typically selects the content for these websites. The number of websites accessible over the Internet estimates millions and as the number of websites and web pages increases, users find it important to have an Internet presence. Many Internet users are increasingly accessing the Internet using their phone or mobile device than using a traditional device such as a desktop or laptop computer.

The subjective importance of a website presence and obstacles relative to their creation has encouraged companies to provide template-based websites for users who either can't afford the traditional costs associated with a website or the time to learn how to create their own.

Website building and publication tools have become increasingly popular for those who might not have the time, skills or funds to hire a web designer or web master. Such tools often provide web page templates that allow users to enter content and select web page layouts, styles, fonts, colors, etc., and then immediately publish the pages to their website. To publish content onto these templates, users typically must find their unstructured, non-categorized content on their desktop or scattered across multiple storage devices, which may not be secure. Then they must follow the protocols of the website building and publication tools to correctly update the content. Since content uploaded is typically unstructured, it is time consuming in search and retrieval as it does not have a pre-defined data model or is not organized in any pre-defined, classified or categorized manner. It is searching, locating and then retrieving of this unstructured, non-organized, non-categorized content which lends to time delays when a website user wishes to relay new or more information relative to their business quickly onto their Website.

Although the complex nature of websites has evolved, management and content changes on websites still remains restricted as to time because of unstructured non-categorized content search, location, retrieval and typically third party intervention. Hence, change and management of content on a website must typically follow a protocol of search, location and retrieval of unstructured non-categorized content, then must wait for said changes to occur by those who understand website design and code. In addition, website content cannot be changed remotely from some device. The instantaneous in-time change of unstructured non-categorized content or its management through a device is tenuous at best or simply not available to the website or website user today.

In today's worldwide Internet environment, websites that do interact with the public to illicit some type of response typically limit content they share about the service entity to a few pictures, name, location and some information as to the services they perform. However, the service, product or information on the website sits unstructured as it originated from information that was not already organized in a departmentalized, categorical way. The content viewed on the website is also unstructured as it is placed in some random fashion as opposed to originating and publishing from a Content Management System.

Further, there is no system where specific content within departmentalized categories (i.e. food, service, location) which are categorized in a Content Management System can further be visually seen on the website.

The current model in practice today prevents the population of content to a website in a departmentalized structured manner where all content uploaded to the website is content organized in a structured, categorical method. As stated, typically desired content to be published to a website must first be located, which is not easily accomplished from conventional storage systems where the retrieval of content follows traditional unstructured, unorganized and non-categorized methodology. When said content is located, it must then be retrieved for third party contractors or the user using website building and/or publication tools to perform the necessary work before said ultimate change in the website occurs. Where one website is populating content that reflects another entity or that entity's website content, content shared by the website from the entity is limited, at best unstructured, or not at all.

Therefore, a solution that would be more practical and desirable for the consumer, service and product entities would be a system and method that allows users to use categorized content on respective websites (URL) through any and all devices, including but not limited to a traditional computing device, mobile device or table device. Said categorical content originating from a secure Content Management System that helps users convert unstructured content into organized, structured and categorized content for specific view, search, retrieval and rating. Viewing content by way of specific categories within a respective website (URL), would allow consumers and users a more detailed and organized view of the service, product or information on the website. Also users could then manage and update their website (URL) content immediately and instantaneously utilizing their devices, which interface with their respective Content Management Systems simultaneously rendering all URL content on all devices.

Hence, it would be more practical and desirable to have a system and method that departmentalizes unstructured content into structured content within a content management system that visually displays hierarchical content that is current in time on a website (URL). The user would be able to manage, change, update and communicate the content on their respective websites (URL) through any and all devices, including but not limited to a traditional computing device, mobile device or tablet device.

### BRIEF SUMMARY OF THE INVENTION

The present invention includes a system and method for departmentalization of structured content on a website (URL) through a secure content management system. The invention provides a method for auto-categorization and classification of any content from users' hard drives or from the Internet stored in the content management system. Content is classified by way of the URL, Supporting URL, Content Detail URL, and Originating URL and categorically classified. As content is modified in any way (i.e. edited, deleted) in the content management system, the same content displayed and published on the website (URL) is also automatically modified throughout all devices where the website (URL) is rendered. During these processes, the content is separated and indexed by way of its component parts. The invention ensures the persistence of content stored from the Internet whether or not the content's supporting URL or originating URL still exists or is deleted or modified. The invention provides a method for classification of content by associations including but not limited to who, what, where when, and why whereby decoupling meta data and content occurs, marking the same content multiple ways which facilitates multiple pathways to retrieving specific content. The invention further includes a system and method whereby content stored in the content management system is visually displayed in a dynamic hierarchy that is current in time. Users of the system are able to initially view relevant content ranked by time. Further, users may search for specific visual content according to the content's associated data thus eliminating time and repetitive actions. The system pushes relevant visual content with associated data to users in real time over a network as a request for data is triggered, providing users with continuous and current hierarchical visual information. The system and method may be used on any and all devices including but not limited to desktop/laptop, mobile and tablet devices. Content shared through the system is automatically rendered throughout all devices using the system.

The following description is presented to enable one of ordinary skill in the art to make and use the invention and is provided in the context of a patent application and its requirements. Various modifications to the embodiment will be readily apparent to those skilled in the art and the generic principles herein may be applied to other embodiments. Thus, the present invention is not intended to be limited to the embodiment shown but is to be accorded the widest scope consistent with the principles and features described herein.

### BRIEF DESCRIPTION OF THE DRAWINGS

FIG. 1 is a block diagram illustrating an exemplary embodiment of the system containing multiple hardware and software components for departmentalization of structured content on a website (URL) through a secure content management system according to the present invention;

FIG. 2 is a flowchart illustrating an exemplary embodiment of a method of how the system determines, identifies, and stores specific elements according to the present invention;

FIG. 3 is a flowchart illustrating an exemplary embodiment of a method of how the system determines, stores, and categorizes specific elements according to the present invention;

FIG. 4 is a flowchart illustrating an exemplary embodiment of a method of how the system is initialized from a client through the server process to associate specific elements according to the present invention;

FIG. 5 is a flowchart illustrating an exemplary embodiment of a method of how the system is initialized from a client through the server process to view content according to the present invention;

FIG. 6 is a flowchart illustrating an exemplary embodiment of a method of how the system pushes relevant visual content according to the present invention;

FIG. 7 is a flowchart illustrating an exemplary embodiment of a method of how the system is initialized from a client through the server process to search and retrieve specific content according to the present invention;

### DETAILED DESCRIPTION

It should be appreciated that the present invention can be implemented in numerous ways, including as a process, or apparatus, a system, or a computer readable medium such as a computer readable storage medium or a computer network wherein program instructions are sent over optical or electronic communication links. It should be noted that the order of disclosed processes may be altered within the scope of the invention.

A detailed description of one or more preferred embodiments of the invention is provided below along with accompanying figures that illustrate by way of example the principles of the invention. While the invention is described in connection with the embodiments, it should be understood that the invention is not limited to any embodiment. On the contrary, the scope of the invention is limited only by the appended claims and the invention encompasses numerous alternatives, modifications, and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

An element according to the present invention encompasses digital content to include but not limited to meta data, text, image files, sound files, and video files. In order for the invention to properly manage, retrieve and display visual hierarchical content, content is sent through a smart server wherein they are processed to a database server and media store server where the content is separated into component parts and associated URL, supporting URL, content detail URL, and originating URL. On the database server textual elements are indexed while on media store server if applicable, a unique identifier is generated in association with an element or document that can be anything from an image file or video file. Requests from users are then sent back through the smart server to the user's browser where the user can view all content containing the request. If pre-existing content is sent through the system, the system will filter out the duplicate content, replacing it with a unique identifier. In this manner, media is stored and retrieved without duplication, while still allowing varied meta data to be associated with said content.

In an exemplary embodiment, the invention is implemented in software, which includes but is not limited to firmware, resident software, microcode, etc. The invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus or device. The medium can be an electronic, magnetic, optical, electromagnetic, infrared, or semiconductor system (or apparatus of device) or a propagation medium.

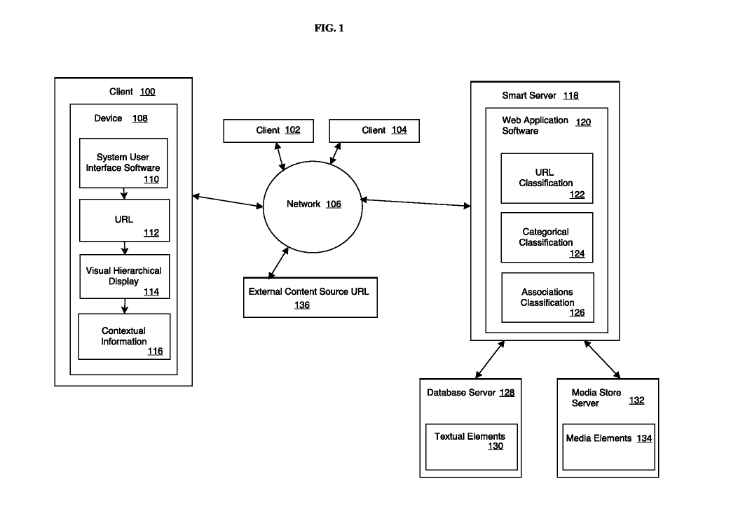

FIG. 1 is a block diagram illustrating an exemplary embodiment of a system displaying multiple hardware and software components of a system for departmentalization of structured content on a website (URL) through a secure content management system. A client's 100 device 108 interacting with a System User Interface Software 110 on a website URL 112 which displays visual hierarchical content 114 and contextual information 116 for content, interacts and sends client 100 commands through the network 106 to a Smart Server 118 where Web Application Software 120 executes said commands to determine, classify, store, retrieve and display content by way of URL Classification 122, Categorical Classification 124 from an external content source URL 136, and Associations Classification 126. The content is processed either to a Database Server 128 where textual element indexing 130 occurs or to a Media Store Server 132 where media elements are assigned unique identifiers 134 in association with relevant applicable content.

The client 100 can then retrieve the content from the Smart Server 118 through the device 108 where the System User Interface Software 110 requests all the elements or parts of the elements. All separated textual elements 130 from Database Server 128 and media elements with unique identifiers 134 from Media Store Server 132 are now transferred to the client 100 through the Web Application Software 120 from the Smart Server 118 through the network 106 interacting with the System User Interface Software 110 where the client 100 visually views the content on a device 108.

Other clients, as represented in 102 and 104 running on other system user interface software may also be connected to the network 106. If the content from the URL is changed, moved, deleted or its access restricted, these clients will be unable to utilize said URLs for content retrieval. Whereas client 100 of this invention will be able to retrieve from the Smart Server 118 the archived content independently of its external existence on its originating server.

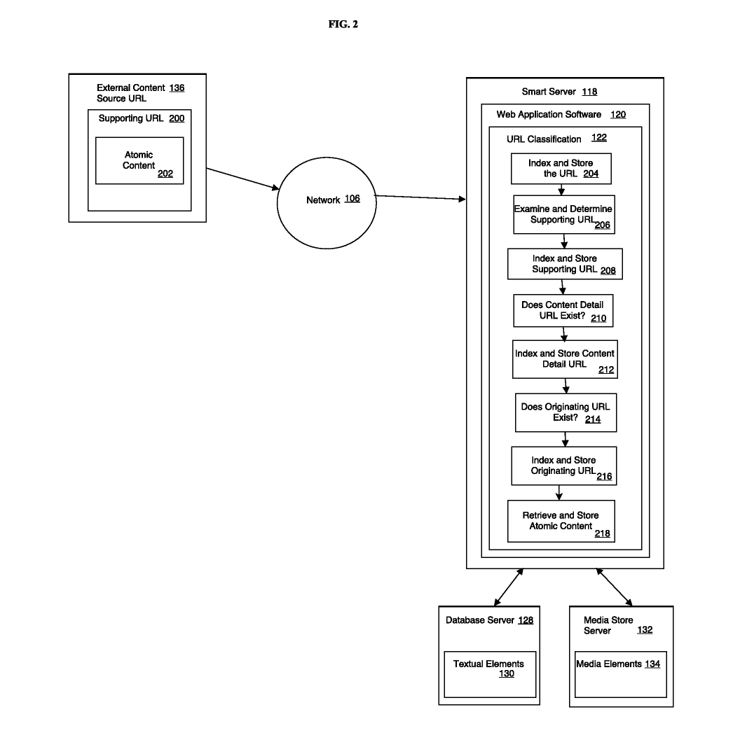

FIG. 2 is a flowchart that further illustrates an exemplary embodiment of a system and method of URL Classification 122 displaying through multiple hardware and software components whereby the atomic content 202 with a supporting URL 200 from an external content source URL 136 is retrieved through the network 106 by the Smart Server 118 where the Web Application Software 120 indexes and stores the URL 204, examines and determines supporting URL 206, indexes and stores supporting URL 208, determines content detail URL 210, indexes and stores content detail URL 212, determines originating URL 214, indexes and stores originating URL 216, and retrieves and stores atomic content 218.

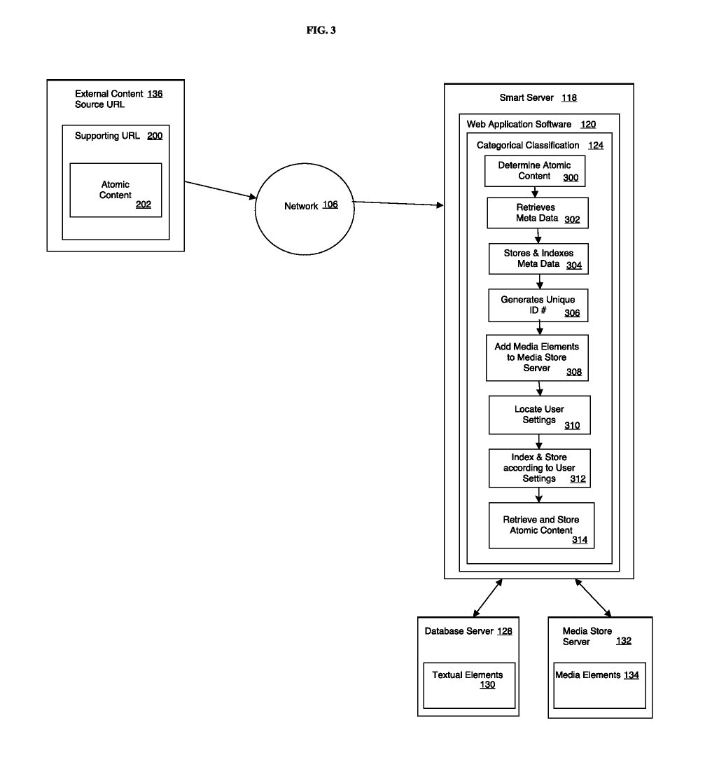

FIG. 3 is a flowchart that further illustrates an exemplary embodiment of a system and method of Categorical Classification 124 displaying through multiple hardware and software components whereby the atomic content 202 with a supporting URL 200 on an external content source URL 136 is retrieved through the network 106 by the Smart Server 118 where the Web Application Software 120 determines atomic content 300, retrieves meta data 302, stores and indexes meta data 304, generates unique id #306, adds media elements to media store server 308, locates user settings 310, indexes and stores according to user settings 312, retrieves and stores atomic content 314.

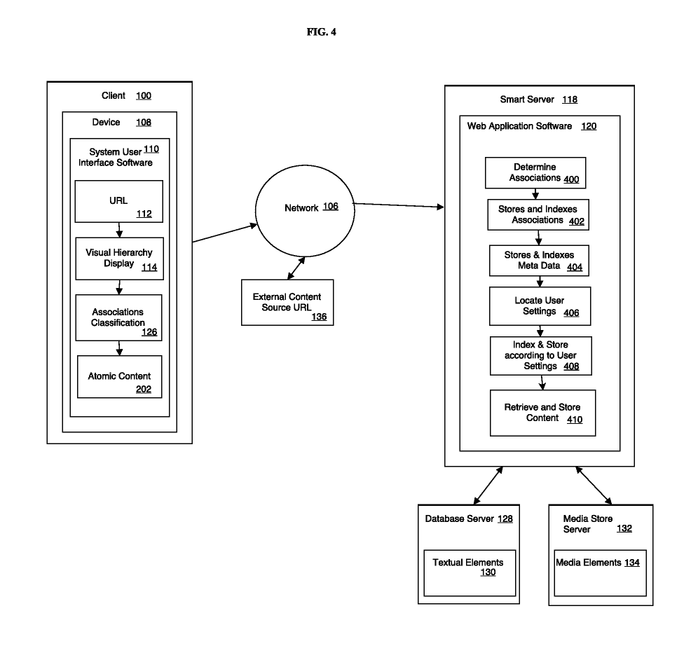

FIG. 4 is a flowchart that further illustrates an exemplary embodiment of a system and method of Associations Classification 126 displaying through multiple hardware and software components whereby the atomic content 202 from an external content source URL 136 is retrieved through the network 106 by the Smart Server 118 where the Web Application Software 120 determines atomic content 400, stores and indexes associations 402, stores and indexes meta data 404, locates user settings 406, indexes and stores according to user settings 408, retrieves and stores content 410.

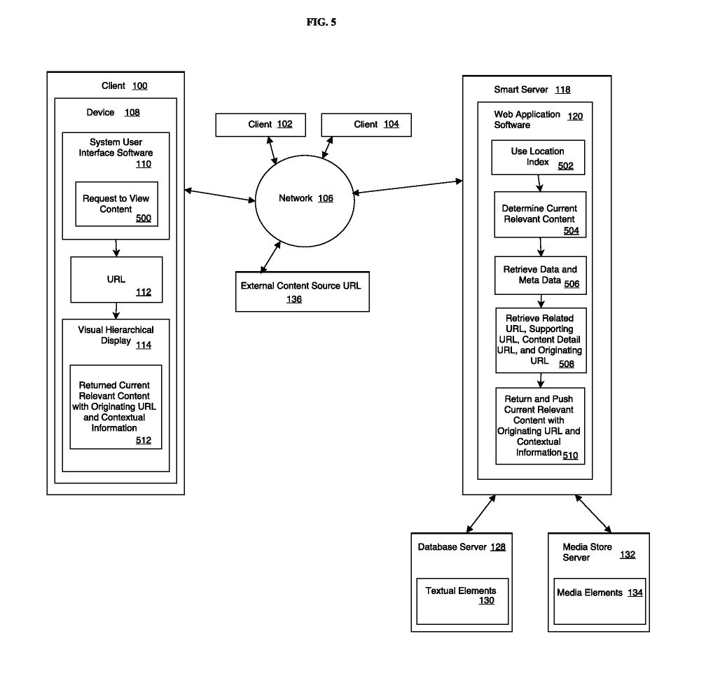

FIG. 5 is a flowchart that further illustrates an exemplary embodiment of a system and method displaying through multiple hardware and software components whereby requests to view content 500 sent from the client 100 interacting with the System User Interface Software 110 through the network 106 are received by the Smart Server 118 where the Web Application Software 120 uses location index 502, determines current relevant content 504, retrieves data and meta data 506, retrieves related URL, supporting URL, content detail URL and originating URL 508, and returns and pushes content with originating URL and contextual information 510 to the client 100 through the network 106 interacting with the System User Interface Software 110 where it is viewed on a URL 112 in a visual hierarchical display 114 as returned current relevant content with originating URL and contextual information 512 on the device 108.

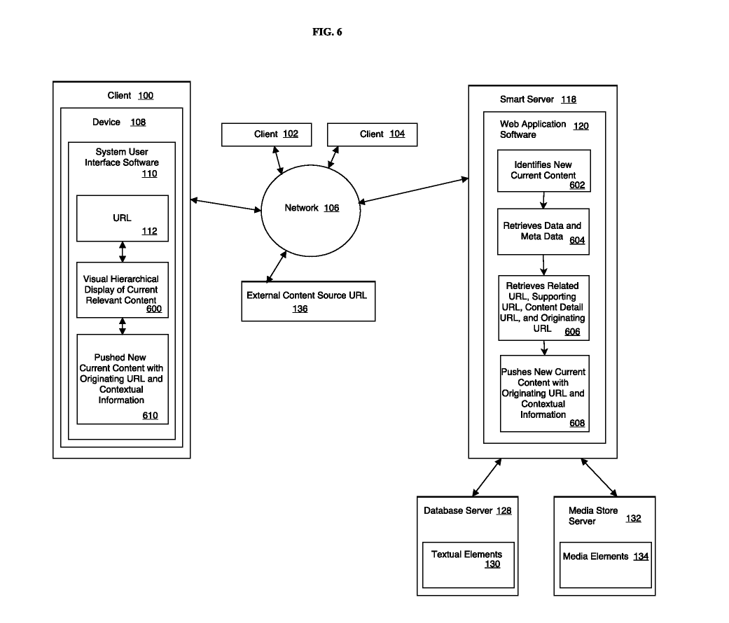

FIG. 6 is a flowchart that further illustrates an exemplary embodiment of a system and method displaying multiple hardware and software components whereby client 100 interacting with the System User Interface Software is viewing a visual hierarchical display of current relevant content 600 wherein simultaneously the Smart Server 118 side interacting with the Web Application Software 120 identifies new current content 602, retrieves data and meta data 604, retrieves related URL, Supporting URL, Content Detail URL, and Origination URL 606, pushes new current content with originating URL and contextual information 608 to the client 100 through the network 106 interacting with the System User Interface Software 110 where it is viewed on a URL 112 in a visual hierarchical display as pushed new current content with originating URL and contextual information 610 on the device 108.

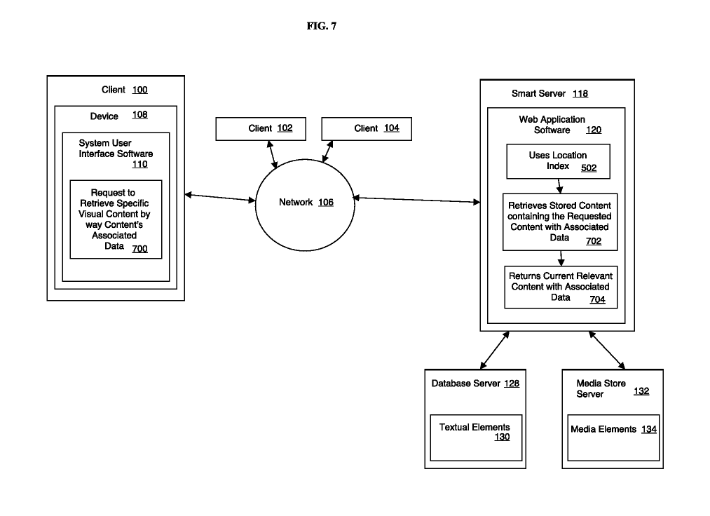

FIG. 7 is a flowchart that further illustrates an exemplary embodiment of a system and method displaying multiple hardware and software components whereby request to retrieve specific visual content by way of content's associated data 700 sent from the client 100 interacting with System User Interface Software 110 through the network 106 are received by the Smart Server 118 where the Web Application Software 120 uses location index 502, retrieves stored content containing the requested content with associated data 702, and returns current relevant content with associated data 704 to the client 100 through the network 106 interacting with the System User Interface Software 110 where it is viewed on a device 108.

What is claimed is:

1. A method, for departmentalization of structured content on a website (URL) through a secure content management system, the method comprising: of an operation to be performed on a smart server; in response to a request at a client device, perform the following steps on a smart server which further interacts with appropriate database server and media store server to: classify, store, and retrieve content; wherein the client device does not block while waiting for the response from the smart server to the request, thereby allowing one or more operations to be performed at the client device after the client device sends the request and before the client device receives the response to the request; receiving from the smart server the stored content on a website URL visually displayed in a dynamic hierarchy that is current in time.

2. A method as recited in claim 1, the method comprising: of an operation to be performed on a smart server by way of URL Classification; in response to the client request, perform the following steps on a smart server which further interacts with the Database Server and Media Store Server to: index and store the URL, examine and determine supporting URL, index and store supporting URL, determine content detail URL, index and store content detail URL, determine originating URL, index and store originating URL, retrieve and store atomic content.

3. A method as recited in claim 1, the method comprising: of an operation to be performed on a smart server by way of Categorical Classification; in response to the client request, perform the following steps on a smart server which further interacts with the Database Server and Media Store Server to: determine atomic content, retrieve meta data and user-specified category, store and index meta data and user-specified category, generate unique id #, add media elements to media store server, locate user settings, index and store according to user settings, retrieve and store atomic content.

4. A method as recited in claim 1, the method comprising: of an operation to be performed on a smart server by way of Associations Classification; in response to the client request, perform the following steps on a smart server which further interacts with the Database Server and Media Store Server to: determine atomic content, store and index associations, store and index meta data, locate user settings, index and store according to user settings, retrieve and store content.

5. A method as recited in claim 1, the method comprising: of an operation to be performed on a smart server; in response to a request at a client device, perform the following steps on a smart server which further interacts with the Database Server and Media Store Server to: use location index, determine current relevant content, retrieve data and meta data, retrieve related URL, supporting URL, content detail URL and originating URL, return and push current relevant content with originating URL and contextual information; receiving at the client device returned current relevant content with originating URL and contextual information on a website URL in a visual hierarchical display.

6. A method as recited in claim 1, the method comprising: of an operation to be performed on a smart server; perform the following steps on a smart server which further interacts with the Database Server and Media Store Server to: identify new current content, retrieve data and meta data, retrieve related URL, supporting URL, content detail URL and originating URL, push new current content with originating URL and contextual information; receiving at the client device pushed new current content with originating URL and contextual information on a website URL in a visual hierarchical display.

7. A method as recited in claim 1, the method comprising: of an operation to be performed on a smart server; in response to a request at a client device, perform the following steps on a smart server which further interacts with the Database Server and Media Store Server to: use location index, retrieve stored content containing the requested content with associated data, and return current relevant content with associated data.

8. A method as recited in claim 1, wherein the client device displays the response via a browser.

9. A method as recited in claim 1, wherein the client device operates on the server data using a programming language that allows for client side modification of server data received.

10. A method as recited in claim 9, wherein the client device comprising of one or more processors, the client device being configured to receive user input that performs a change that requires an operation to be performed on the smart server; respond to the client input by: generating a request for the operation to be performed on the smart server; one or more operations to be performed in response to the request; and sending the response to the client device.

11. A method for a computer readable medium on a client device, the method comprising: receiving user input at a client device that performs a change that requires an operation to be performed on the smart server; in response to the user input, perform the following steps on the client device: generating request for the operation to be performed on the smart server; and sending the request to the smart server; wherein the client device does not block while waiting for the response from the smart server to the request, thereby allowing one or more operations to be performed at the client device after the client device sends the request and before the client device receives the response to the request; receiving the response, processing elements that were generated upon the user input.

12. A method as recited in claim 11, wherein the client device displays the response via a browser.

13. A method as recited in claim 11, wherein the client device operates on the server data using a programming language that allows for client side modification of server data received.

14. A method as recited in claim 13, wherein the client device comprising of one or more processors, the client device being configured to receive user input that performs a change that requires an operation to be performed on the smart server; respond to the client input by: generating a request for the operation to be performed on the smart server; one or more operations to be performed in response to the request; and sending the response to the client device.
